(19) United States
(12) Patent Application Publication
(10) Pub. No.: US 2025/0140211 A1
(43) Pub. Date: May 1, 2025

(54) DISPLAY DEVICE

(71) Applicant: Sharp Display Technology Corporation, Kameyama City (JP)

(72) Inventor: Kohei HORIBATA, Kameyama City (JP)

(21) Appl. No.: 18/897,147

(22) Filed: Sep. 26, 2024

(30) Foreign Application Priority Data
Nov. 1, 2023 (JP) 2023-187828

(51) Int. Cl. G09G 3/34

(52) U.S. Cl. CPC G09G 3/3406; G09G 2320/0233; G09G 2320/0247; G09G 2320/064

(57) ABSTRACT

A display device includes a backlight, a display panel that displays an image by transmitting light from the backlight, and a control unit. In a case where a frame frequency of an image that is displayed on the display panel is a first frequency, the control unit causes the backlight to emit light in a first amount of emitted light, and in a case where the frame frequency is a second frequency that is lower than the first frequency, the control unit causes the backlight to emit light in a second amount of emitted light that is larger than the first amount of emitted light.

### BACKGROUND

### 1. Field

The technology disclosed herein relates to a display device.

### 2. Description of the Related Art

There has been known a technology for, for the purpose of reducing the amount of electricity that is consumed by a display device, switching the frame frequency (drive frequency) of a display panel according to an image that is displayed.

Switching the frame frequency entails a change in the luminance of the display panel. Specifically, decreasing the frame frequency causes a decrease in the frequency of refreshing of the image, so that increases in leak current from pixel electrodes within one frame cause decreases in voltage of the pixel electrodes. The decreases in voltage entail decreases in the transmittance of light that passes through pixels, resulting in a decrease in the luminance of the display panel. On the other hand, increasing the frame frequency causes an increase in the luminance of the display panel. A change in the luminance of the display panel causes flickering of the image.

As a technology capable of suppressing a change in luminance, a liquid crystal display device disclosed in Japanese Unexamined Patent Application Publication No. 2007-171948 is known. According to a description of Japanese Unexamined Patent Application Publication No. 2007-171948, a change in luminance is suppressed by minimizing black data that is inserted as measures against image retention.

Reducing black data can suppress a decrease in luminance but increases image retention, possibly resulting in deterioration of display quality. There has been demand for a method for suppressing a change in the luminance of a display panel other than the method that involves an increase or decrease in black data. It is desirable to provide a display device capable of suppressing a change in the luminance of a display panel even with a change in frame frequency.

### SUMMARY

According to an aspect of the disclosure, there is provided a display device including a backlight, a display panel that displays an image by transmitting light from the backlight, and a control unit. In a case where a frame frequency of an image that is displayed on the display panel is a first frequency, the control unit causes the backlight to emit light in a first amount of emitted light, and in a case where the frame frequency is a second frequency that is lower than the first frequency, the control unit causes the backlight to emit light in a second amount of emitted light that is larger than the first amount of emitted light.

### BRIEF DESCRIPTION OF THE DRAWINGS

FIG. 1 is a side view showing a structure of a liquid crystal display device;

FIG. 2 is an electric block diagram of the liquid crystal display device;

FIG. 3 is a graph of voltage in PWM modulated light;

FIGS. 4A and 4B are graphs showing transmittance;

FIGS. 5A and 5B are graphs showing the amount of emitted light from a backlight;

FIG. 6 is a graph showing the luminance of a display panel;

FIGS. 7A and 7B are a graphs showing transmittance (Embodiment 2);

FIGS. 8A and 8B are graphs showing the amount of emitted light from a backlight (Embodiment 2); and

FIG. 9 is a graph showing the luminance of a display panel (Embodiment 2).

### DESCRIPTION OF THE EMBODIMENTS

### Embodiment 1

### 1. Configuration of Liquid Crystal Display Device

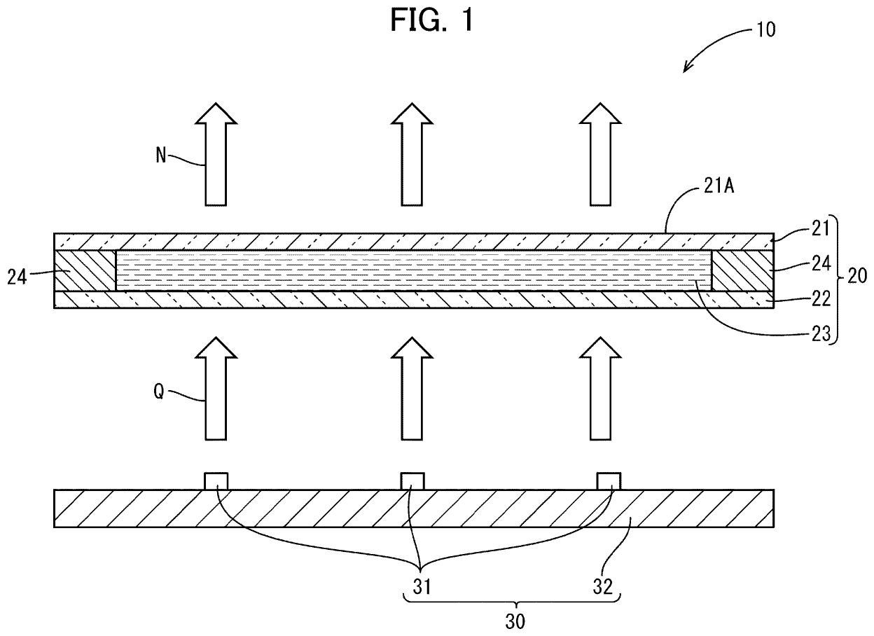

Embodiment 1 is described with reference to FIGS. 1 to 6. The present embodiment illustrates a liquid crystal display device 10. The liquid crystal display device 10 is an example of a “display device”. The liquid crystal display device 10 is a device that displays images in accordance with input signals that are inputted from an outside source. The images include still images and moving images.

### Liquid Crystal Panel

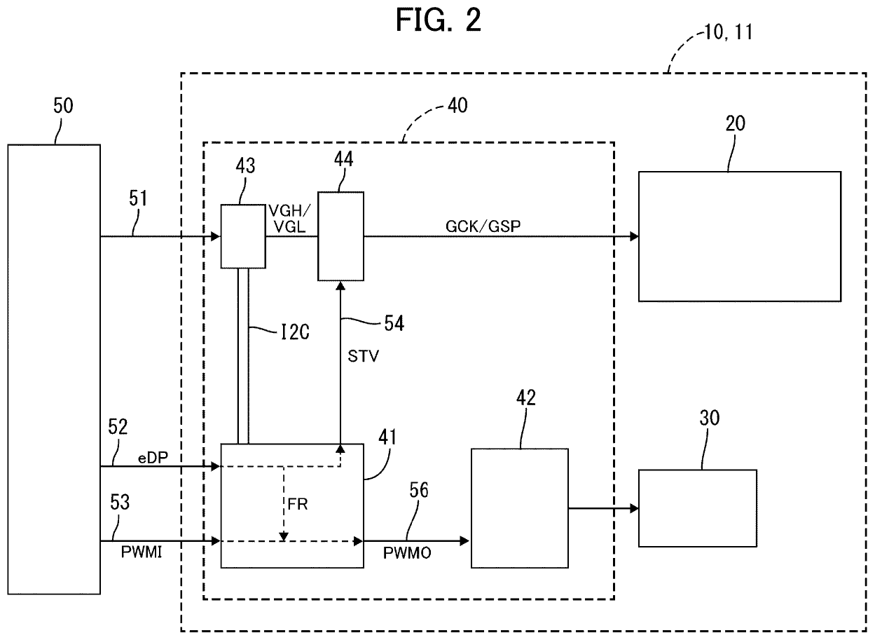

FIG. 1 shows a cross-sectional view of the liquid crystal display device 10 according to the present embodiment. The liquid crystal display device 10 includes a liquid crystal panel 20 (which is an example of a “display panel”), a backlight 30 that emits light to the liquid crystal panel 20 in an amount of emitted light Q (which is variably controllable), and a control unit 40 (see FIG. 2). The front of the liquid crystal display device 10 is the side at which the liquid crystal panel 20 is located, and the back of the liquid crystal display device 10 is the side at which the backlight 30 is located. The front of the liquid crystal display device 10 faces upward in FIG. 1, and the back of the liquid crystal display device 10 faces downward in FIG. 1.

The liquid crystal panel 20 is constituted by a pair of glass substrates 21 and 22 bonded together. Of the pair of glass substrates 21 and 22, the glass substrate 21, which is located further away from the backlight 30 (further forward) than the glass substrate 22, has an outer surface serving as a display surface 21A on which an image is displayed. A polarizing plate is bonded to a front principal surface of the glass substrate 21, and a polarizing plate is bonded to a back principal surface of the glass substrate 22.

A liquid crystal layer 23 is sandwiched between the pair of glass substrates 21 and 22. The liquid crystal layer 23 contains liquid crystal molecules that make up a substance whose optical characteristics vary in the presence of the application of an electric field. A seal member 24 is provided between outer peripheral ends of the pair of glass substrates 21 and 22. The seal member 24 seals the liquid crystal layer 23. The seal member 24 is formed to surround the liquid crystal layer 23.

Alignment films, electrodes, transistors, color filters, or other elements are formed in layers between inner sides of the glass substrates 21 and 22 that face each other. When the after-mentioned control unit 40 applies a gate voltage VG to the liquid crystal panel 20, the orientation of the liquid crystal molecules contained in the liquid crystal layer 23 can be arbitrarily changed on the basis of a gradation voltage. Changing the orientation causes a change in the light transmittance G of the liquid crystal panel 20, making it possible to change the display gradation of an image that is displayed on the display surface 21A.

### Backlight

The backlight 30 is placed further backward than the liquid crystal panel 20. The backlight 30 includes a plurality of light sources 31 and a plate-shaped support substrate 32 on which the light sources 31 are mounted. The light sources 31 are, for example, white LED elements that emit white light. The light sources 31 are planarly disposed at the back of the liquid crystal panel 20. The backlight 30 is a so-called direct backlight device.

A wiring pattern made of an electrical conducting material is formed on the support substrate 32, and electric power is supplied to each light source 31 through the wiring pattern. The electric power that is supplied to the light sources 31 is subjected to PWM (pulse width modulation) by the control unit 40, so that the amount of emitted light Q emitted by the backlight 30 can be arbitrarily adjusted.

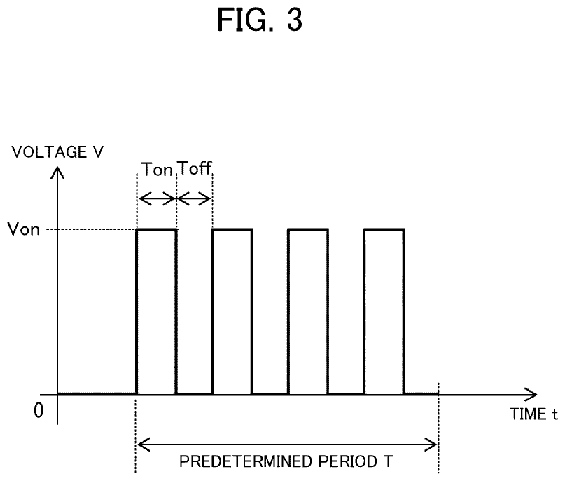

An outline of PWM control is described with reference to FIG. 3. In FIG. 3, the horizontal axis represents time, and the vertical axis represents a drive voltage V that is inputted to the light sources 31. The light sources 31 emit light at a certain level of brightness when a predetermined voltage Von is applied.

In order for the light sources 31 to achieve the desired amount of emitted light Q in a predetermined period T (e.g. a one-frame period), an OFF period Toff during which no voltage is applied and an ON period Ton during which the drive voltage Von is applied in pulse waves are alternately repeated. The OFF period Toff is a non-emission period during which the light sources 31 emit no light. The ON period Ton is an emission period during which the light sources 31 emit light. The ratio of the ON period Ton to the predetermined period T is a duty ratio. In a case where the amount of emitted light Q is increased, the duty ratio is increased (that is, the ratio of the ON period Ton is increased, and the ratio of the OFF period Toff is decreased). On the other hand, in a case where the amount of emitted light Q is decreased, the duty ratio is decreased (that is, the ratio of the ON period Ton is decreased, and the ratio of the OFF period Toff is increased).

By changing the duty ratio, the control unit 40 allows light to be emitted in an arbitrary amount of emitted light Q from the back toward the liquid crystal panel 20.

### Control Unit

FIG. 2 is a block diagram showing an electrical configuration of the liquid crystal display device 10. The control unit 40 includes a timing controller 41, an LED driver 42, a power source IC 43, a level shifter 44, or other elements. The elements of the control unit 40 are communicably connected to one another as indicated by arrows in FIG. 2. The timing controller 41 and the power source IC 43 are connected to each other by an I2C (Inter-Integrated Circuit) interface serial bus.

An input signal 50 that is inputted to the control unit 40 contains a power supply voltage 51, an eDP (embedded Display Port) video signal 52, a PWM input signal 53, or other signals. The power supply voltage 51 is a voltage for driving the liquid crystal panel 20. The eDP video signal 52 is a signal standardized for image input and output and is signal containing a frame frequency FR and the after-mentioned STV signal 54.

The power supply voltage 51 is a drive voltage of the liquid crystal panel 20. The power source IC 43 converts the power supply voltage 51 thus inputted into a gate voltage VG (VGH, VGL) and outputs the gate voltage VG to the level shifter 44.

Upon receiving the eDP video signal 52, the timing controller 41 recognizes the frame frequency FR contained in the eDP video signal 52. Further, the timing controller 41 generates the STV signal 54 from the eDP video signal 52. The STV signal 54 thus generated is inputted to the power source IC 43 and the level shifter 44.

The level shifter 44 converts the gate voltage VG received from the power source IC 43 and the STV signal 54 into a gate clock GCK and a gate start pulse GSP. The liquid crystal panel 20 is driven at timings based on the gate clock GCK and the gate start pulse GSP inputted from the level shifter 44. The gate voltage VG is applied at predetermined timings to individual pixels included in the liquid crystal panel 20, so that the light transmittance G is changed for each pixel.

Further, the timing controller 41 receives the PWM input signal 53 contained in the input signal 50 at the same timing as the generation of the STV signal 54. The timing controller 41 corrects the duty ratio of the PWM input signal 53 with reference to the frame frequency FR and generates a PWM output signal 56. The PWM output signal 56 is transmitted from the timing controller 41 to the LED driver 42.

In accordance with the PWM output signal 56 thus received, the LED driver 42 causes the light sources 31 of the backlight 30 to emit light at the duty ratio thus corrected. As shown in FIG. 1, emitted light (amount of emitted light Q) generated by emission of the light sources 31 passes through the liquid crystal panel 20 driven by the gate voltage VG, so that an image is displayed at a luminance N on the display surface 21A of the liquid crystal panel 20.

### 2. Relationship Between Frame Frequency and Luminance of Liquid Crystal Panel

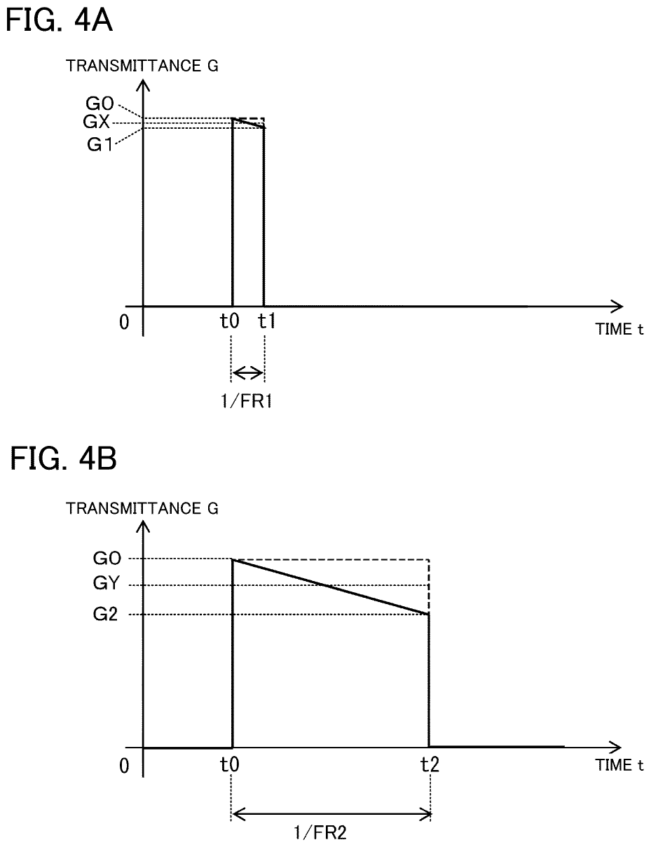

A relationship between the frame frequency FR and the luminance N of the liquid crystal panel 20 is described with reference to FIG. 4A to FIG. 6. The luminance N of the liquid crystal panel 20 during a one-frame period is determined by two parameters, namely the amount of emitted light Q from the backlight 30 and the average of transmittance during the one-frame period.

The gate voltage VG is applied every one-frame period, which is the reciprocal of the frame frequency FR. For simplicity, the following description deals with one pixel and assumes that the amount of emitted light Q from the backlight 30 is maintained at the same amount of light during a one-frame period.

FIG. 4A is a graph showing a temporal change in the transmittance G when the frame frequency FR is a first frequency FR1. The first frequency FR1 is, for example, 60 Hz.

When the gate voltage VGH is applied to the pixel at time t0, the transmittance G of the pixel rises to G0. When the gate voltage VGL of a next frame is applied to the pixel at time t1, at which a one-frame period (1/FR1) has elapsed, the pixel is refreshed, so that the transmittance G becomes, for example, 0 for the next frame.

FIG. 4B is a graph showing a temporal change in the transmittance G when the frame frequency FR is a second frequency FR2 that is lower than the first frequency FR1. The second frequency FR2 is, for example, 1 Hz.

When the same gate voltage VGH as in FIG. 4A is applied at time t0, the transmittance G rises to G0. When the gate voltage VGL of a next frame is applied to the pixel at time t2, at which a one-frame period (1/FR2) has elapsed, the transmittance G becomes, for example, 0 for the next frame.

It is desirable that the transmittance G during the one-frame period (1/FR1 or 1/FR2) stay the same at the transmittance G0 at the time of application of the voltage as indicated by a dashed line in FIG. 4A or 4B. However, in actuality, due to leak current leaking out from the pixel or other leakage, the gate voltage VG decreases as time proceeds.

Therefore, as indicated by a solid line in FIG. 4A or 4B, the transmittance G gradually decreases as time proceeds after the application of the gate voltage VGH. When the frame frequency FR is the first frequency FR1, as shown in FIG. 4A, the transmittance G decreases from G0 to G1 during the one-frame period. The average of transmittance GX during the one-frame period assumes a value of G0 to G1.

On the other hand, at the second frequency FR2, as shown in FIG. 4B, the transmittance G gradually decreases from G0 to G2 during the one-frame period. At the second frequency FR2, the one-frame period is longer than it is at the first frequency FR1, and there are more leak current or other leakage during the one-frame period. Therefore, the margin of decrease in the transmittance G at the second frequency FR2 is greater than the margin of decrease in the transmittance G at the first frequency FR1, so that G1>G2. Therefore, the average of transmittance GY during the one-frame period is lower than GX (GX>GY).

Even in a case where an identical gate voltage VGH is applied, the average of transmittance GY at the second frequency FR2 is lower than the average of transmittance GX at the first frequency FR1 (GX>GY). Decreasing the frame frequency of the liquid crystal panel 20 from the first frequency FR1 to the second frequency FR2 causes the average of transmittance to decrease from GX to GY.

On the other hand, when the frame frequency FR increases from the second frequency FR2 to the first frequency FR1, the average of transmittance increases from GY to GX.

3. Amount of Emitted Light from Backlight

Since a change in the luminance N of the liquid crystal panel 20 causes flickering of a display image, a change in the luminance N needs to be suppressed.

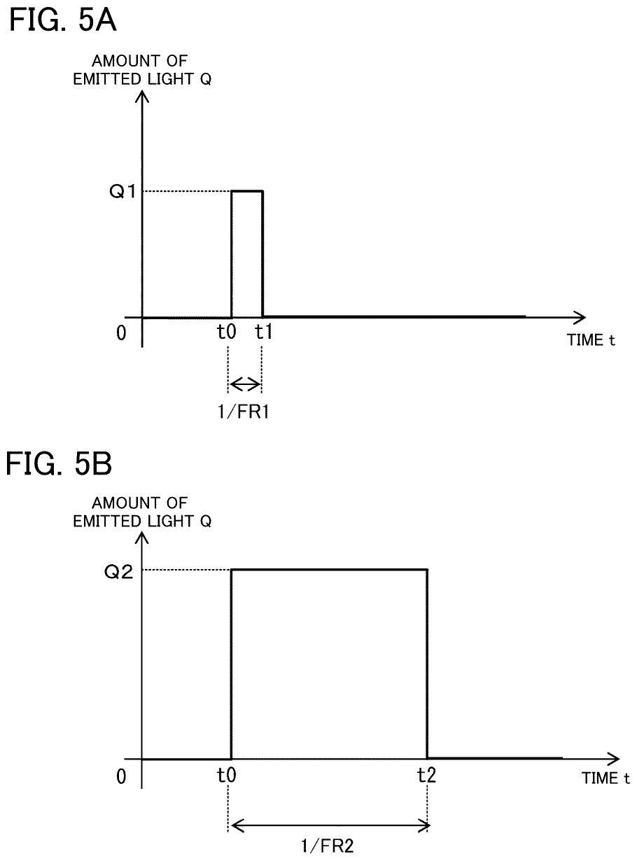

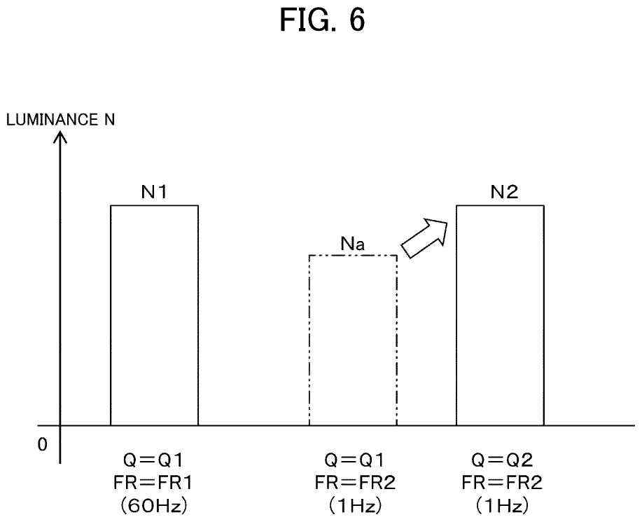

FIG. 5A is a graph of the amount of emitted light Q that corresponds to the timing of the application of the voltage of FIG. 4A. When the frame frequency FR is the first frequency FR1, the control unit 40 causes the backlight 30 to emit light in a first amount of emitted light Q1 during the period from time t0 to time t1. Assume here that the liquid crystal panel 20 displays an image at a luminance N1 as indicated in a left part of the graph of FIG. 6.

As mentioned above, the average of transmittance GY at the second frequency FR2 is lower than the average of transmittance GX at the first frequency FR1. Therefore, when the frame frequency FR decreases from the first frequency FR1 to the second frequency FR2, the average of transmittance decreases from GX to GY. If the amount of emitted light Q from the backlight 30 stays the same at the first amount of emitted light Q1 before and after the change in the frame frequency FR, there is a decrease in the amount of light that passes through the liquid crystal panel 20 and reaches the front. As a result of that, as indicated by a chain double-dashed line in FIG. 6, the luminance of the liquid crystal panel 20 decreases from N1 to Na.

Meanwhile, FIG. 5B is a graph of the amount of emitted light Q that corresponds to the timing of the application of the voltage at the second frequency FR2 shown in FIG. 4B. In the liquid crystal display device 10 of the present embodiment, when the frame frequency FR is the second frequency FR2, the control unit 40 causes the backlight 30 to emit light in a second amount of emitted light Q2 during the period from time t0 to time t2. The second amount of emitted light Q2 is larger than the first amount of emitted light Q1.

In this way, more light enters the liquid crystal panel 20 from behind the liquid crystal panel 20, making it possible to compensate for the decrease in transmitted light due to the low average of transmittance GY.

As shown in FIG. 6, the luminance of the liquid crystal panel 20 is N2 when the backlight 30 is caused at the second frequency FR2 to emit light in the second amount of emitted light Q2. The luminance N2 is higher than the luminance Na, as the amount of emitted light Q from the backlight 30 is large (Q2>Q1).

Since the decrease in the luminance N caused by the decrease in the average of transmittance is compensated for by increasing the amount of emitted light Q, a difference between the luminance N1 and the luminance N2 is smaller than a difference between the luminance N1 and the luminance Na. This makes it possible to reduce the occurrence of flickering by suppressing the decrease in the luminance N attributed to the decrease in the frame frequency FR.

The value of the second amount of emitted light Q2 at which a decrease in the luminance N entailed by a decrease in the frame frequency FR can be suppressed may be obtained in advance by an experiment or a simulation. A data table associating the frame frequency FR1 before change and the frame frequency FR2 after change with the values of the amounts of emitted light Q1 and Q2 at which a change in the luminance N can be suppressed before and after a change in the frame frequency FR is prepared and stored in advance in the control unit 40 or a storage medium. In changing the frame frequency from FR1 to FR2, the amount of emitted light Q2 that corresponds to the frame frequency FR2 after change can be quickly read out by referring to the data table stored.

### Embodiment 2

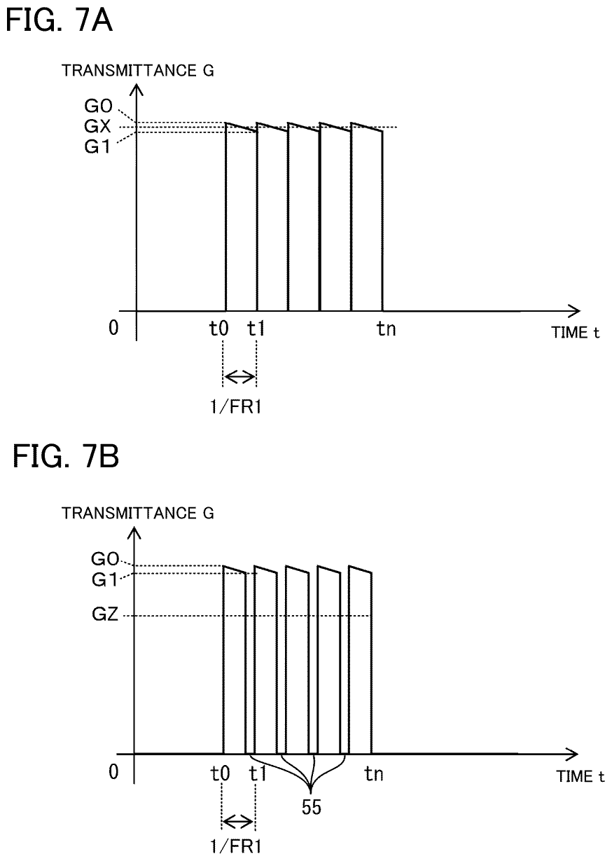

Next, a liquid crystal display device 11 according to Embodiment 2 of the present disclosure is described with reference to FIG. 7A to FIG. 9. The present embodiment uses identical reference signs for the same components as those of Embodiment 1 described above and omits a repeated description of structures, workings, and effects.

The control unit 40 inserts black data into at least one or more of a plurality of frames. Black data is data to be displayed at a minimum of gradation with the transmittance G of the liquid crystal panel 20 at a minimum value (e.g. 0) only during a predetermined section of a one-frame period. Inserting black data causes an image to be displayed at the minimum of gradation between a frame and a frame, reducing inter-frame image retention and bringing about improvement in display quality of the image.

FIG. 7A shows temporal changes in the transmittance G for five frames with no black data inserted, and FIG. 7B shows temporal changes in the transmittance G for five frames with black data inserted. The frame frequency FR is the first frequency FR1 in both FIG. 7A and FIG. 7B.

As shown in FIG. 7A, in a case where no black data is inserted, the transmittance G rises to the transmittance G0 upon application of a gate voltage VG at time to and then falls to G1 at time t1, at which a one-frame period (1/FR1) has elapsed. When a one-frame period elapses, the gate voltage VG is applied again, and then the transmittance G repeatedly falls. The average of transmittance GX during a one-frame period assumes a value falling between the transmittance G0 at the time of the application of the gate voltage VG and the transmittance G1 immediately before the next application of the gate voltage VG.

On the other hand, as shown in FIG. 7B, when black data is inserted, a black data period 55 during which the transmittance G assumes the minimum value (0) is inserted in a one-frame period from the rising of the transmittance G to the transmittance G0 upon application of a gate voltage VG at time t0 to the next application of the gate voltage VG. The average of transmittance GZ over a one-frame period with black data inserted assumes a lower value than does the average of transmittance GX with no black data inserted.

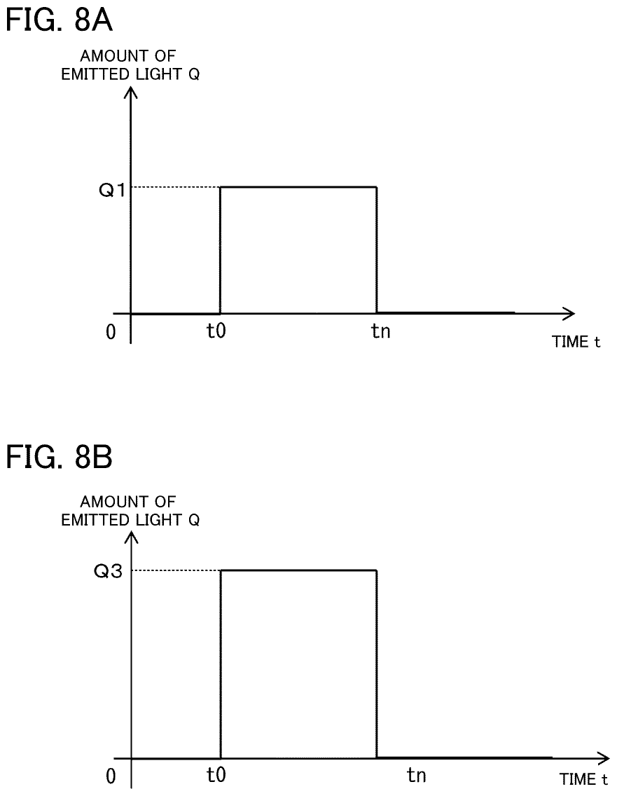

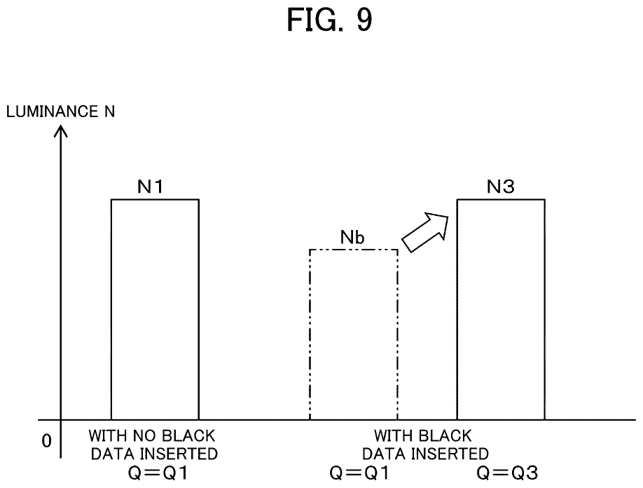

FIG. 8A shows, in correspondence with the timing of the application of the voltage of FIG. 7A, that in a case where no black data is inserted, the amount of emitted light Q is the first amount of emitted light Q1. In the case of the first amount of emitted light Q1 with no black data inserted, the liquid crystal panel 20 displays an image at the luminance N1 at the time of the first amount of emitted light Q1 as indicated in a left part of the graph of FIG. 9.

On the other hand, FIG. 8B shows, in correspondence with the timing of the application of the voltage of FIG. 7B, a third amount of emitted light Q3 with no black data inserted. In the liquid crystal display device 11 according to Embodiment 2, the third amount of emitted light Q3 with black data inserted assumes a greater value than does the first amount of emitted light Q1 with no black data inserted.

Even if the transmittance G0 at the rising edge stays the same at G0 in the presence of the application of the same gate voltage VG, insertion of black data causes the average of transmittance to decrease from GX to GZ. Therefore, in a case where the amount of emitted light Q from the backlight 30 stays the same at Q1 before and after the insertion of the black data, the insertion of the black data causes a decrease in the amount of light that passes through the liquid crystal panel 20, so that the luminance N decreases.

The luminance Nb indicated by a chain double-dashed line in FIG. 9 is the luminance of the liquid crystal panel 20 in the case of the first amount of emitted light Q1 with black data inserted. Under the influence of the decrease in the average of transmittance (from GX to GZ) caused by the insertion of the black data, the luminance Nb becomes lower than the luminance N1 in the case of the first amount of emitted light Q1.

In the liquid crystal display device 11 of the present embodiment, the amount of emitted light for displaying a frame having black data inserted thereinto is increased from the first amount of emitted light Q1 for displaying a frame having no black data inserted thereinto to the third amount of emitted light Q3. Increasing the amount of emitted light causes more light to be emitted toward the liquid crystal panel 20. The luminance N3 in the case of the third amount of emitted light Q3 with black data inserted is indicated in a right part of FIG. 9.

By increasing the amount of emitted light from the first amount of emitted light Q1 to the third amount of emitted light Q3 in inserting black data, the luminance of the liquid crystal panel 20 is increased from the luminance Nb, which applies in a case where the first amount of emitted light Q1 is maintained, to the luminance N3. By so doing, the decrease in the average of transmittance (from GX to GZ) caused by the insertion of the black data is compensated for by the increase in the amount of emitted light (from Q1 to Q3), so that the decrease in the luminance of the liquid crystal panel 20 can be suppressed. At the same time, the occurrence of image retention is reduced by the insertion of the black data.

### Other Embodiments

The technology disclosed herein is not limited to the embodiments described above with reference to the description and the drawings. Embodiments such as those described below are encompassed in the technical scope of the present disclosure.
(1) Each of the foregoing embodiments has been described by taking as an example a liquid crystal display device including a liquid crystal panel. An embodiment of the present disclosure is not limited to a liquid crystal display device but may be directed to a display device including a display panel other than a liquid crystal panel.
(2) Each of the foregoing embodiments has illustrated a so-called direct backlight whose light sources are placed immediately below a liquid crystal panel. The backlight does not need to be of a direct type. The backlight may be an edge-lighted backlight whose light sources are placed at an edge of a display panel and whose light is diffused by a light guide plate or may be another type of backlight.

Although each of the foregoing embodiments has been described by taking as an example a case where the first frequency is 60 Hz and the second frequency is 1 Hz, the frame frequency is not limited to these numerical values. The first frequency may be higher than 60 Hz. For example, the first frequency may be 30 Hz or 120 Hz. The present disclosure is applicable in a case where the second frequency is a frequency that is relatively lower than the first frequency.

According to Embodiment 1 described above, in a case where the frame frequency is the second frequency, which is lower than the first frequency, a decrease in luminance can be suppressed by increasing the amount of emitted light from the backlight. In other words, in a case where the frame frequency is increased from the second frequency to the first frequency, an increase in luminance can be suppressed by decreasing the amount of emitted light. Accordingly, the present disclosure can be applied at both the time of a change from a relatively high frequency to a low frequency and the time of a change from a relatively low frequency to a high frequency.

According to Embodiment 2 described above, a decrease in luminance can be suppressed by making the amount of emitted light larger during a period of display of a frame having black data inserted thereinto than during a period of display of a frame having no black data inserted thereinto. In other words, an increase in luminance can be suppressed by making the amount of emitted light smaller during a period of display of a frame having no black data inserted thereinto than during a period of display of a frame having black data inserted thereinto. Accordingly, the present disclosure can be applied in both the case of insertion of black data into an image having no black data inserted thereinto and the case of removal of black data having black data inserted thereinto.

The present disclosure contains subject matter related to that disclosed in Japanese Priority Patent Application JP 2023-187828 filed in the Japan Patent Office on Nov. 1, 2023, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A display device comprising:
a backlight;
a display panel that displays an image by transmitting light from the backlight; and
a control unit,
wherein
in a case where a frame frequency of an image that is displayed on the display panel is a first frequency, the control unit causes the backlight to emit light in a first amount of emitted light, and
in a case where the frame frequency is a second frequency that is lower than the first frequency, the control unit causes the backlight to emit light in a second amount of emitted light that is larger than the first amount of emitted light.

2. The display device according to claim 1, wherein
the control unit causes the display panel to display an image with black data inserted in at least one or more frames, the black data being displayed at a minimum of gradation for a predetermined period of one frame,
during a period of display of a frame not having the black data inserted thereinto, the control unit causes the backlight to emit light in the first amount of emitted light, and
during a period of display of a frame having the black data inserted thereinto, the control unit causes the backlight to emit light in a third amount of emitted light that is larger than the first amount of emitted light.
